(19) United States
(12) Patent Application Publication
(10) Pub. No.: US 2024/0015603 A1
(43) Pub. Date: Jan. 11, 2024

(54) TECHNIQUES FOR MODIFYING THRESHOLD VALUES IN A SYSTEM INFORMATION BLOCK

(71) Applicant: QUALCOMM Incorporated, San Diego, CA (US)

(72) Inventors: Kuo-Chun LEE, San Diego, CA (US); Arvind Vardarajan SANTHANAM, San Diego, CA (US); Shanshan WANG, San Diego, CA (US); Hewu GU, Shanghai (CN); Xianwei ZHU, Beijing (CN); Jun DENG, Shanghai (CN); Xuepan GUAN, San Diego, CA (US)

(21) Appl. No.: 18/260,541

(22) PCT Filed: Mar. 24, 2021
(86) PCT No.: PCT/CN2021/082664

§ 371 Date: Jul. 6, 2023

(51) Int. Cl. H04W 36/00; H04W 36/08

(52) U.S. Cl. CPC H04W 36/0022; H04W 36/08

(57) ABSTRACT

Got Various aspects of the present disclosure generally relate to wireless communication. In some aspects, a user equipment (UE) may switch between a first radio access technology (RAT) and a second RAT based at least in part on a condition. The UE may modify, based at least in part on the switching, a second RAT threshold value in a system information block (SIB), to obtain a modified second RAT threshold value, wherein the modified second RAT threshold value is a value to switch from the first RAT to the second RAT. Numerous other aspects are described.

### FIELD OF THE DISCLOSURE

Aspects of the present disclosure generally relate to wireless communication and to techniques and apparatuses for modifying threshold values in a system information block (SIB).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a UE includes switching between a first radio access technology (RAT) and a second RAT based at least in part on a condition; and modifying, based at least in part on the switching, a second RAT threshold value in a system information block (SIB), to obtain a modified second RAT threshold value, wherein the modified second RAT threshold value is a value to switch from the first RAT to the second RAT.

In some aspects, the method includes determining that a signal level associated with the second RAT does not satisfy the modified second RAT threshold value.

In some aspects, the first RAT is associated with an LTE network, the second RAT is associated with an NR network, and the modified second RAT threshold value is a modified NR threshold value.

In some aspects, switching between the first RAT and the second RAT based at least in part on the condition is based at least in part on a quantity of switches between the first RAT and the second RAT during a time period satisfying a threshold.

In some aspects, switching between the first RAT and the second RAT based at least in part on the condition is based at least in part on a time duration between the UE switching from the first RAT to the second RAT and switching from the second RAT back to the first RAT satisfying a threshold.

In some aspects, a target cell associated with the second RAT has a higher cell reselection priority than a source cell associated with the first RAT.

In some aspects, a target cell associated with the second RAT has a lower cell reselection priority or an equal cell priority as compared to a source cell associated with the first RAT.

In some aspects, modifying the second RAT threshold value in the SIB, to obtain the modified second RAT threshold value, comprises replacing the second RAT threshold value in a SIB24 with a second RAT threshold value from a previously received second RAT SIB and an offset value.

In some aspects, modifying the second RAT threshold value in the SIB, to obtain the modified second RAT threshold value, comprises replacing the second RAT threshold value in a SIB24 with a first RAT threshold value from a previously received first RAT SIB and an offset value.

In some aspects, the first RAT threshold value is an LTE threshold value and the previously received first RAT SIB is a previously received LTE SIB.

In some aspects, the modified second RAT threshold value is configured to expire based at least in part on an expiry of a timer.

In some aspects, the modified second RAT threshold value prevents the UE from switching between the first RAT and the second RAT a quantity of times that satisfies a first threshold or within a time duration that satisfies a second threshold.

In some aspects, the modified second RAT threshold value is one or more of: a second RAT reference signal received power threshold value or a second RAT reference signal received quality power threshold.

In some aspects, modifying the second RAT threshold value in the SIB comprises modifying the second RAT threshold value in a SIB24 locally created at the UE and not broadcasted from a base station associated with the first RAT.

In some aspects, a UE for wireless communication includes a memory and one or more processors, coupled to the memory, configured to: switch between a first RAT and a second RAT based at least in part on a condition; and modify, based at least in part on the switching, a second RAT threshold value in a SIB, to obtain a modified second RAT threshold value, wherein the modified second RAT threshold value is a value to switch from the first RAT to the second RAT.

In some aspects, the one or more processors are further configured to determine that a signal level associated with the second RAT does not satisfy the modified second RAT threshold value.

In some aspects, the first RAT is associated with an LTE network, the second RAT is associated with an NR network, and the modified second RAT threshold value is a modified NR threshold value.

In some aspects, switching between the first RAT and the second RAT based at least in part on the condition is based at least in part on a quantity of switches between the first RAT and the second RAT during a time period satisfying a threshold.

In some aspects, switching between the first RAT and the second RAT based at least in part on the condition is based at least in part on a time duration between the UE switching from the first RAT to the second RAT and switching from the second RAT back to the first RAT satisfying a threshold.

In some aspects, a target cell associated with the second RAT has a higher cell reselection priority than a source cell associated with the first RAT.

In some aspects, a target cell associated with the second RAT has a lower cell reselection priority or an equal cell priority as compared to a source cell associated with the first RAT.

In some aspects, the one or more processors, to modify the second RAT threshold value in the SIB, to obtain the modified second RAT threshold value, are configured to replace the second RAT threshold value in a SIB24 with a second RAT threshold value from a previously received second RAT SIB and an offset value.

In some aspects, the one or more processors, to modify the second RAT threshold value in the SIB, to obtain the modified second RAT threshold value, are configured to replace the second RAT threshold value in a SIB24 with a first RAT threshold value from a previously received first RAT SIB and an offset value.

In some aspects, the first RAT threshold value is an LTE threshold value and the previously received first RAT SIB is a previously received LTE SIB.

In some aspects, the modified second RAT threshold value is configured to expire based at least in part on an expiry of a timer.

In some aspects, the modified second RAT threshold value prevents the UE from switching between the first RAT and the second RAT a quantity of times that satisfies a first threshold or within a time duration that satisfies a second threshold.

In some aspects, the modified second RAT threshold value is one or more of: a second RAT reference signal received power threshold value, or a second RAT reference signal received quality power threshold.

In some aspects, the one or more processors, to modify the second RAT threshold value in the SIB, are configured to modify the second RAT threshold value in a SIB24 locally created at the UE and not broadcasted from a base station associated with the first RAT.

In some aspects, a non-transitory computer-readable medium storing a set of instructions for wireless communication includes one or more instructions that, when executed by one or more processors of a UE, cause the UE to: switch between a first RAT and a second RAT based at least in part on a condition; and modify, based at least in part on the switching, a second RAT threshold value in a SIB, to obtain a modified second RAT threshold value, wherein the modified second RAT threshold value is a value to switch from the first RAT to the second RAT.

In some aspects, the one or more instructions further cause the UE to determine that a signal level associated with the second RAT does not satisfy the modified second RAT threshold value.

In some aspects, the first RAT is associated with an LTE network, the second RAT is associated with an NR network, and the modified second RAT threshold value is a modified NR threshold value.

In some aspects, switching between the first RAT and the second RAT based at least in part on the condition is based at least in part on a quantity of switches between the first RAT and the second RAT during a time period satisfying a threshold.

In some aspects, switching between the first RAT and the second RAT based at least in part on the condition is based at least in part on a time duration between the UE switching from the first RAT to the second RAT and switching from the second RAT back to the first RAT satisfying a threshold.

In some aspects, a target cell associated with the second RAT has a higher cell reselection priority than a source cell associated with the first RAT.

In some aspects, a target cell associated with the second RAT has a lower cell reselection priority or an equal cell priority as compared to a source cell associated with the first RAT.

In some aspects, the one or more instructions, that cause the UE to modify the second RAT threshold value in the SIB, to obtain the modified second RAT threshold value, cause the UE to replace the second RAT threshold value in a SIB24 with a second RAT threshold value from a previously received second RAT SIB and an offset value.

In some aspects, the one or more instructions, that cause the UE to modify the second RAT threshold value in the SIB, to obtain the modified second RAT threshold value, cause the UE to replace the second RAT threshold value in a SIB24 with a first RAT threshold value from a previously received first RAT SIB and an offset value.

In some aspects, the first RAT threshold value is an LTE threshold value and the previously received first RAT SIB is a previously received LTE SIB.

In some aspects, the one or more instructions further cause the UE to expire based at least in part on an expiry of a timer.

In some aspects, the modified second RAT threshold value prevents the UE from switching between the first RAT and the second RAT a quantity of times that satisfies a first threshold or within a time duration that satisfies a second threshold.

In some aspects, the modified second RAT threshold value is one or more of: a second RAT reference signal received power threshold value or a second RAT reference signal received quality power threshold.

In some aspects, the one or more instructions, that cause the UE to modify the second RAT threshold value in the SIB, cause the UE to modify the second RAT threshold value in a SIB24 locally created at the UE and not broadcasted from a base station associated with the first RAT.

In some aspects, an apparatus for wireless communication includes means for switching between a first RAT and a second RAT based at least in part on a condition; and means for modifying, based at least in part on the switching, a second RAT threshold value in a SIB, to obtain a modified second RAT threshold value, wherein the modified second RAT threshold value is a value to switch from the first RAT to the second RAT.

In some aspects, the apparatus includes means for determining that a signal level associated with the second RAT does not satisfy the modified second RAT threshold value.

In some aspects, the first RAT is associated with an LTE network, the second RAT is associated with an NR network, and the modified second RAT threshold value is a modified NR threshold value.

In some aspects, switching between the first RAT and the second RAT based at least in part on the condition is based at least in part on a quantity of switches between the first RAT and the second RAT during a time period satisfying a threshold.

In some aspects, switching between the first RAT and the second RAT based at least in part on the condition is based at least in part on a time duration between the UE switching from the first RAT to the second RAT and switching from the second RAT back to the first RAT satisfying a threshold.

In some aspects, a target cell associated with the second RAT has a higher cell reselection priority than a source cell associated with the first RAT.

In some aspects, a target cell associated with the second RAT has a lower cell reselection priority or an equal cell priority as compared to a source cell associated with the first RAT.

In some aspects, the means for modifying the second RAT threshold value in the SIB, to obtain the modified second RAT threshold value, comprises means for replacing the second RAT threshold value in a SIB24 with a second RAT threshold value from a previously received second RAT SIB and an offset value.

In some aspects, the means for modifying the second RAT threshold value in the SIB, to obtain the modified second RAT threshold value, comprises means for replacing the second RAT threshold value in a SIB24 with a first RAT threshold value from a previously received first RAT SIB and an offset value.

In some aspects, the first RAT threshold value is an LTE threshold value and the previously received first RAT SIB is a previously received LTE SIB.

In some aspects, the apparatus includes means for expiring based at least in part on an expiry of a timer.

In some aspects, the modified second RAT threshold value prevents the UE from switching between the first RAT and the second RAT a quantity of times that satisfies a first threshold or within a time duration that satisfies a second threshold.

In some aspects, the modified second RAT threshold value is one or more of: a second RAT reference signal received power threshold value, or a second RAT reference signal received quality power threshold.

In some aspects, the means for modifying the second RAT threshold value in the SIB comprises means for modifying the second RAT threshold value in a SIB24 locally created at the UE and not broadcasted from a base station associated with the first RAT.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIGS. 3-4 are diagrams illustrating examples of a ping-pong behavior at a UE involving an LTE-to-NR reselection and an NR-to-LTL reselection, in accordance with the present disclosure.

FIGS. 5-7 are diagrams illustrating examples associated with modifying threshold values in a SIB, in accordance with the present disclosure.

FIG. 8 is a diagram illustrating an example process associated with modifying threshold values in a SIB, in accordance with the present disclosure.

FIG. 9 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

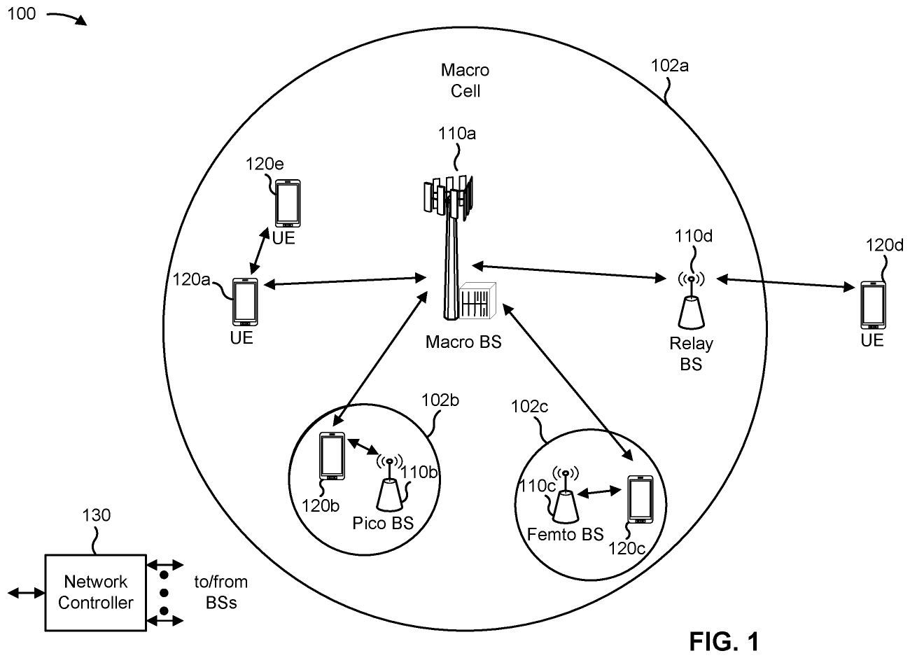

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

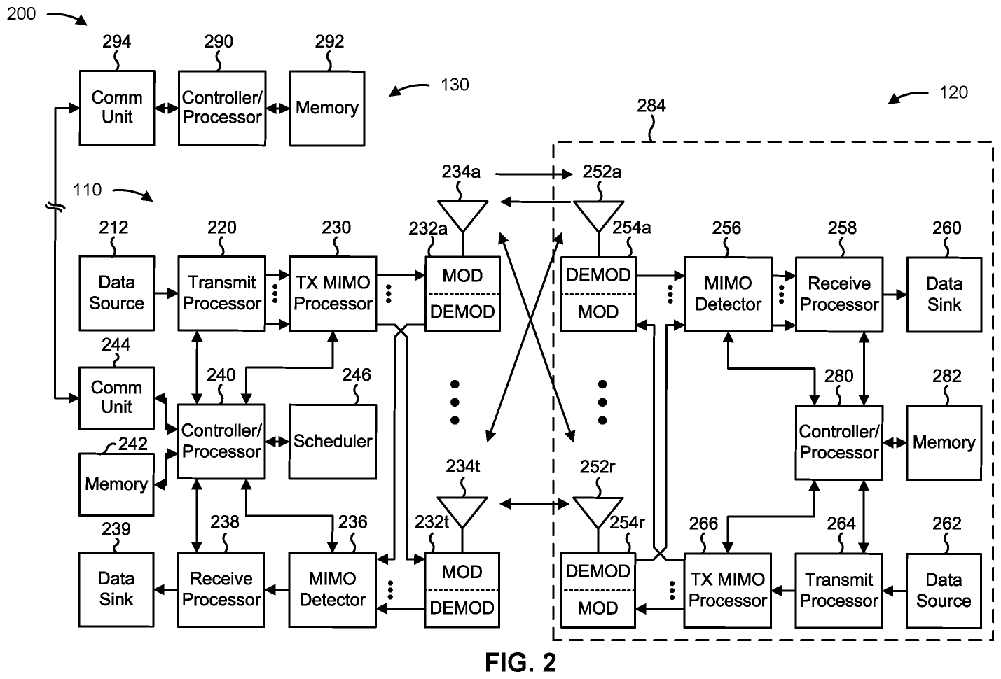

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

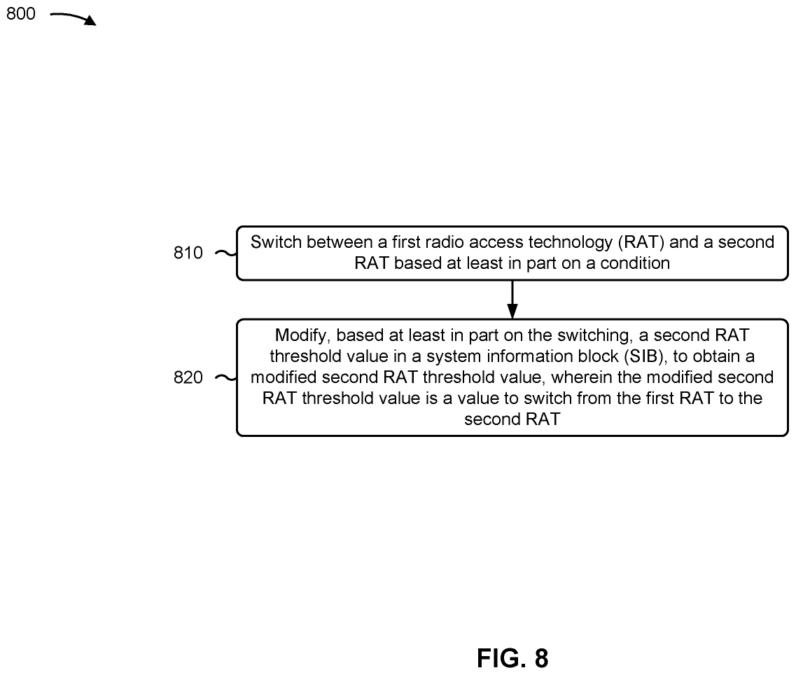

Controller/processor 240 of base station 110, controller/processor 280 of UE 120, and/or any other component(s) of FIG. 2 may perform one or more techniques associated with modifying threshold values in a SIB, as described in more detail elsewhere herein. For example, controller/processor 240 of base station 110, controller/processor 280 of UE 120, and/or any other component(s) of FIG. 2 may perform or direct operations of, for example, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some aspects, executing instructions may include running the instructions, converting the instructions, compiling the instructions, and/or interpreting the instructions.

In some aspects, a UE (e.g., UE 120) includes means for switching between a first RAT and a second RAT based at least in part on a condition; and/or means for modifying, based at least in part on the switching, a second RAT threshold value in a SIB, to obtain a modified second RAT threshold value, wherein the modified second RAT threshold value is a value to switch from the first RAT to the second RAT. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining that a signal level associated with the second RAT does not satisfy the modified second RAT threshold value.

As indicated above, FIG. 2 is provided as an example. Other examples may differ from what is described with regard to FIG. 2.

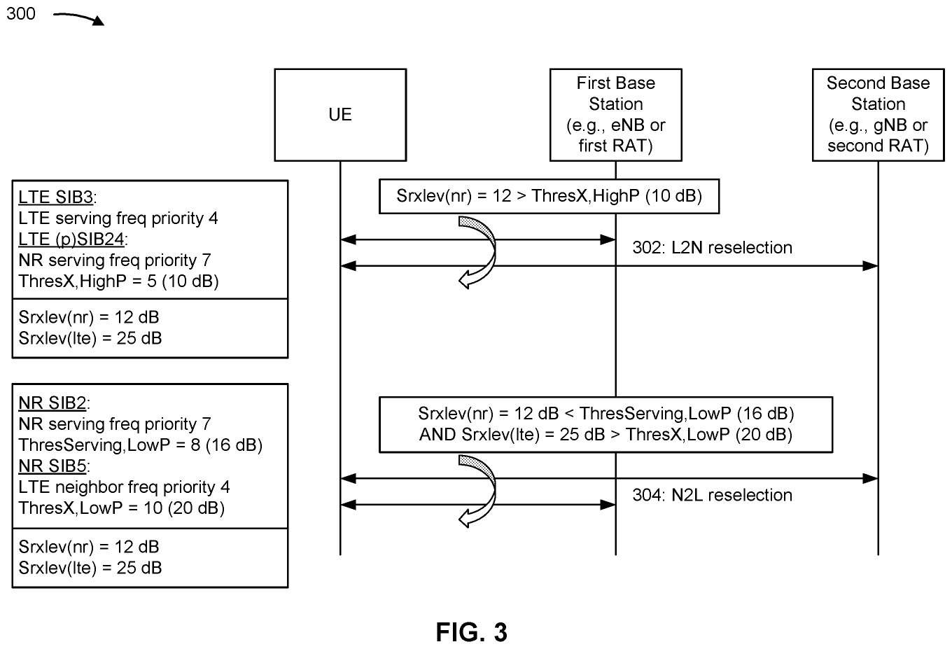

FIG. 3 is a diagram illustrating an example 300 of a ping-pong behavior at a UE involving an LTE-to-NR reselection and an NR-to-LTE reselection, in accordance with the present disclosure. As shown in FIG. 3, example 300 includes communication between a UE (e.g., UE 120), a first base station (e.g., base station 110a), and a second base station (e.g., base station 110d). In some aspects, the UE, the first base station, and the second base station may be included in a wireless network such as wireless network 100.

The first base station (e.g., an eNB) may be associated with an LTE network, and the second base station (e.g., gNB) may be associated with an NR network. The first base station and the LTE network may be associated with a first RAT, and the second base station and the NR network may be associated with a second RAT. In other words, LTE may be associated with the first RAT and NR may be associated with the second RAT.

When the UE is connected to the LTE network, the UE may receive, from the first base station, an LTE system information block 3 (SIB3). The LTE SIB3 may configure an LTE serving frequency priority value (e.g., 4). The UE may receive, from the first base station, an LTE SIB24. The LTE SIB24 may configure an NR serving frequency priority value (e.g., 7) and an NR threshold value (e.g., ThresX,HighP for an RSRP threshold value and/or ThresX,HighQ for an RSRQ threshold value). For example, the NR threshold value may be equal to 10 dB.

In this example, NR may have a higher priority than LTE (e.g., the NR serving frequency priority value of 7 is greater than the LTE serving frequency priority value of 4). In other words, a target NR cell may have a higher cell reselection priority than a source LTE cell.

When the UE is connected to the LTE network, the UE may measure a power level of an NR signal (e.g., Srxlev(nr)) of 12 dB, and the UE may measure a power level of an LTE signal (e.g. Srxlev(lte)) of 25 dB. The power level of the NR signal and the power level of the LTE signal may be based at least in part on RSRP/RSRQ values associated with the NR signal and the LTE signal. The UE may check whether the power level of the NR signal is greater than the NR threshold value based at least in part on the NR serving frequency priority value being greater than the LTE serving frequency priority value. The UE may determine that the power level of the NR signal (e.g., Srxlev(nr)) of 12 dB is greater than the NR threshold value (e.g., ThresX,HighP for an RSRP threshold value and/or ThresX,HighQ for an RSRQ threshold value) of 10 dB.

As shown by reference number 302, the UE may perform an LTE-to-NR (L2N) reselection based at least in part on the power level of the NR signal being greater than the NR threshold value. The UE may switch from the first base station to the second base station based at least in part on the LTE-to-NR reselection. The LTE-to-NR reselection may be an inter-RAT (IRAT) reselection.

The UE may determine whether to perform the LTE-to-NR reselection based at least in part on the NR threshold value indicated in the LTE SIB24, as received from the first base station. In some cases, the UE may not receive the LTE SIB24 from the first base station. Rather, the UE may determine a pseudo LTE SIB24. The pseudo LTE SIB24 may be a locally created LTE SIB24 when the LTE network does not deploy LTE SIB24. The pseudo LTE SIB24 may indicate the NR threshold value, which may enable the UE to determine whether to perform the LTE-to-NR reselection.

When the UE is connected to the NR network, the UE may receive, from the second base station, an NR SIB2. The NR SIB2 may configure an NR serving frequency priority value (e.g., 7) and an NR threshold value (e.g., ThresServing,LowP). For example, the NR threshold value may be equal to 16 dB. The UE may receive, from the second base station, an NR SIBS. The NR SIBS may configure an LTE neighbor frequency priority value (e.g., 4) and an LTE threshold value (e.g., ThresX,LowP for an RSRP threshold value and/or ThresX,LowQ for an RSRQ threshold value). For example, the LTE threshold value may be equal to 20 dB.

When the UE is connected to the NR network, the UE may measure a power level of an NR signal (e.g., Srxlev(nr)) of 12 dB, and the UE may measure a power level of an LTE signal (e.g. Srxlev(lte)) of 25 dB. The UE may determine that the power level of the NR signal (e.g., Srxlev(nr)) of 12 dB is less than the NR threshold value of 16 dB. Further, the UE may determine that the power level of the LTE signal (e.g. Srxlev(lte)) of 25 dB is greater than the LTE threshold value of 20 dB. In other words, the power level of the NR signal may be relatively low and the power level of the LTE signal may be relatively high.

As shown by reference number 304, the UE may perform an NR-to-LTE (N2L) reselection based at least in part on the power level of the NR signal being less than the NR threshold value. The UE may switch from the second base station back to the first base station based at least in part on the NR-to-LTE reselection. When the UE performs the LTE-to-NR reselection, and then performs the NR-to-LTL reselection within a period of time that satisfies a threshold, the UE may exhibit the ping-pong behavior as the UE may transition to the NR network and then back to the LTE network in a relatively short amount of time.

As indicated above, FIG. 3 is provided as an example. Other examples may differ from what is described with regard to FIG. 3.

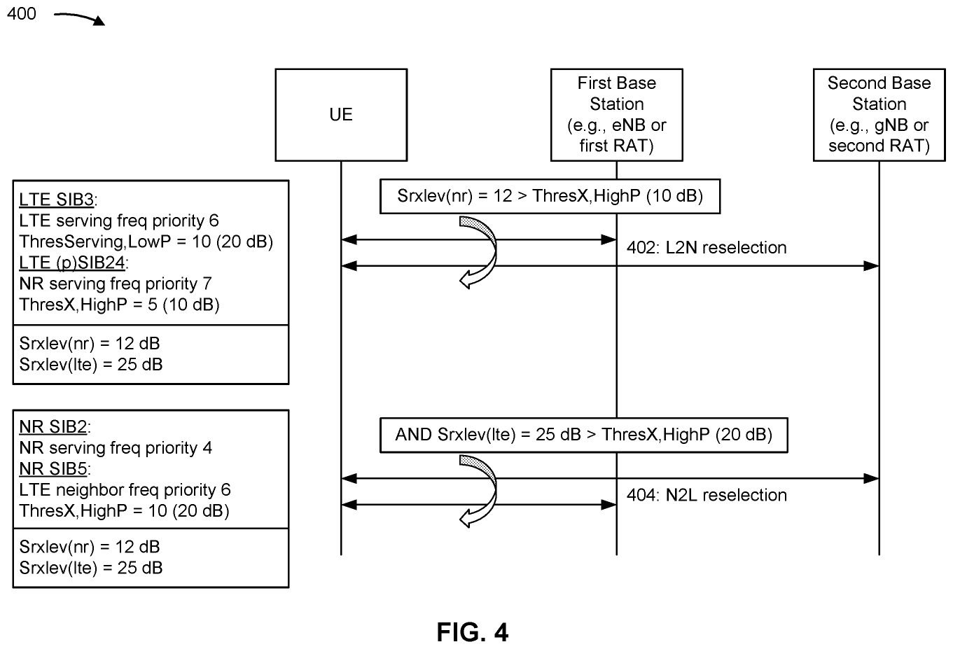

FIG. 4 is a diagram illustrating an example 400 of a ping-pong behavior at a UE involving an LTE-to-NR reselection and an NR-to-LTE reselection, in accordance with the present disclosure. As shown in FIG. 4, example 400 includes communication between a UE (e.g., UE 120), a first base station (e.g., base station 110a), and a second base station (e.g., base station 110d). In some aspects, the UE, the first base station, and the second base station may be included in a wireless network such as wireless network 100.

The first base station (e.g., an eNB) may be associated with an LTE network, and the second base station (e.g., gNB) may be associated with an NR network. The first base station and the LTE network may be associated with a first RAT and the second base station and the NR network may be associated with a second RAT. In other words, LTE may be associated with the first RAT and NR may be associated with the second RAT.

When the UE is connected to the LTE network, the UE may receive, from the first base station, an LTE system information block 3 (SIB3). The LTE SIB3 may configure an LTE serving frequency priority value (e.g., 6) and an LTE threshold value (e.g., ThresServing,LowP). For example, the LTE threshold value may be equal to 20 dB. The UE may receive, from the first base station, an LTE SIB24. The LTE SIB24 may configure an NR serving frequency priority value (e.g., 7) and an NR threshold value (e.g., ThresX,HighP for an RSRP threshold value and/or ThresX,HighQ for an RSRQ threshold value). For example, the NR threshold value may be equal to 10 dB.

In this example, in the LTE network, NR may have a higher priority than LTE (e.g., the NR serving frequency priority value of 7 is greater than the LTE serving frequency priority value of 6). In other words, in the LTE network, a target NR cell may have a higher cell reselection priority than a source LTE cell.

When the UE is connected to the LTE network, the UE may measure a power level of an NR signal (e.g., Srxlev(nr)) of 12 dB, and the UE may measure a power level of an LTE signal (e.g. Srxlev(lte)) of 25 dB. The power level of the NR signal and the power level of the LTE signal may be based at least in part on RSRP/RSRQ values associated with the NR signal and the UE signal. The UE may check whether the power level of the NR signal is greater than the NR threshold value based at least in part on the NR serving frequency priority value being greater than the LTE serving frequency priority value. The UE may determine that the power level of the NR signal (e.g., Srxlev(nr)) of 12 dB is greater than the NR threshold value (e.g., ThresX,HighP for an RSRP threshold value and/or ThresX,HighQ for an RSRQ threshold value) of 10 dB.

As shown by reference number 402, the UE may perform an LTE-to-NR (L2N) reselection based at least in part on the power level of the NR signal being greater than the NR threshold value. The UE may switch from the first base station to the second base station based at least in part on the LTE-to-NR reselection.

When the UE is connected to the NR network, the UE may receive, from the second base station, an NR SIB2. The NR SIB2 may configure an NR serving frequency priority value (e.g., 4). The UE may receive, from the second base station, an NR SIBS. The NR SIBS may configure an LTE neighbor frequency priority value (e.g., 6) and an LTE threshold value (e.g., ThresX,HighP for an RSRP threshold value and/or ThresX,HighQ for an RSRQ threshold value). For example, the LTE threshold value may be equal to 20 dB.

In this example, in the NR network, LTE may have a higher priority than NR (e.g., the LTE neighbor frequency priority value of 6 is greater than the NR serving frequency priority value of 4). In other words, in the NR network, a target LTE cell may have a higher cell reselection priority (or in some cases, an equal cell reselection priority) than a source NR cell.

When the UE is connected to the NR network, the UE may measure a power level of an NR signal (e.g., Srxlev(nr)) of 12 dB, and the UE may measure a power level of an LTE signal (e.g. Srxlev(lte)) of 25 dB. The UE may check whether the power level of the LTE signal is greater than the LTE threshold value based at least in part on the LTE neighbor frequency priority value being greater than the NR serving frequency priority value. The UE may determine that the power level of the LTE signal (e.g., Srxlev(lte)) of 25 dB is greater than the LTE threshold value (e.g., ThresX,HighP for an RSRP threshold value and/or ThresX,HighQ for an RSRQ threshold value) of 20 dB. In other words, the power level of the LTE signal may be relatively high and the power level of the NR signal may be relatively low.

As shown by reference number 404, the UE may perform an NR-to-LTE (N2L) reselection based at least in part on the power level of the LTE signal being greater than the LTE threshold value. The UE may switch from the second base station back to the first base station based at least in part on the NR-to-LTE reselection.

As indicated above, FIG. 4 is provided as an example. Other examples may differ from what is described with regard to FIG. 4.

The UE may initially be connected to the LTE network, may connect to the NR network, and then may return to the LTE network. The UE may exhibit a ping-pong behavior by connecting to the NR network, and then returning back to the LTE network. This ping-pong behavior of moving back and forth between the LTE network and the NR network may be undesirable, as continually connecting between different networks may increase a signaling overhead at the UE. In some cases, when the UE is connected to the LTE network, the UE should stay in the LTE network and not connect to the NR network, since a likelihood that the UE moves back to the LTE network may be relatively high. Thus, avoiding this ping-pong behavior of moving back and forth between the LTE network and the NR network may be beneficial to the UE.

In various aspects of techniques and apparatuses described herein, a UE may detect a ping-pong behavior of the UE. For example, the UE may detect a switching of the UE between an LTE network (e.g., a first RAT) and an NR network (e.g., a second RAT) based at least in part on a condition. The condition may be that a quantity of switches between the LTE network and the NR network during a time period satisfies a threshold. Additionally, or alternatively, the condition may be that a time duration between the UE switching from the LTE network to the NR network and then switching from the NR network back to the LTE network satisfies a threshold. The UE may modify, based at least in part on the switching, an NR threshold value (e.g., a second RAT threshold value) in a SIB to obtain a modified NR threshold value (e.g., a modified second RAT threshold value). The modified NR threshold value may be a value to switch from the LTE network to the NR network. The modified NR threshold value may prevent the UE from unnecessarily switching from the LTE network to the NR network (e.g., switching to the NR network and then returning to the LTE network within a relatively short period of time). The UE may determine that a signal level associated with NR does not satisfy the modified NR threshold value. As a result, the UE may stay connected to the LTE network and may not connect to the NR network, thereby avoiding the situation in which the UE returns back to the LTE network in a relatively short amount of time.

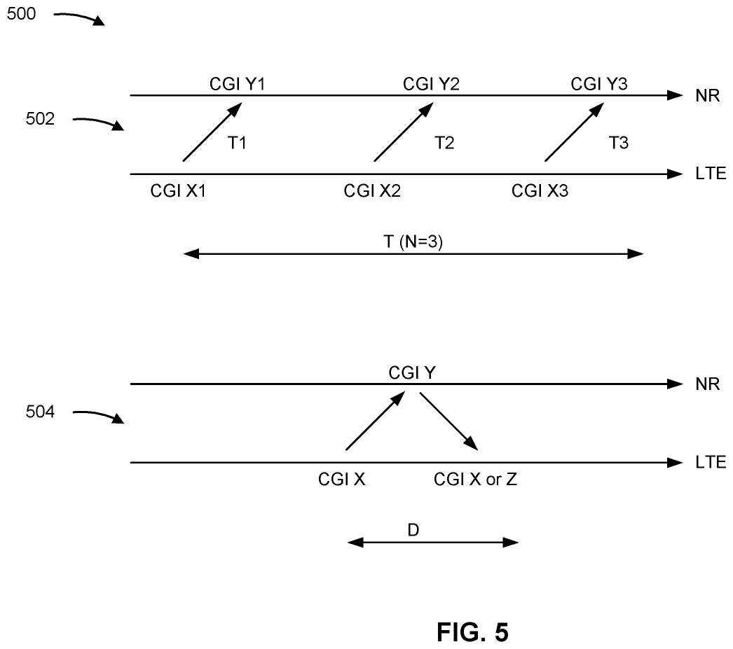

FIG. 5 is a diagram illustrating an example 500 associated with modifying threshold values in a SIB, in accordance with the present disclosure.

In some aspects, a UE may detect a ping-pong behavior based at least in part on a list that indicates a plurality of LTE-to-NR reselections. The list may indicate, for each of the plurality of LTE-to-NR reselections, an LTE-to-NR reselection target NR frequency and a corresponding time stamp. In other words, the list may indicate that that the UE performed a quantity of LTE-to-NR reselections over a period of time. When the quantity of LTE-to-NR reselections over the period of time satisfies a threshold, the UE may detect the ping-pong behavior. In other words, the UE may detect that the UE has moved back and forth between an NR network and an LTE network a relatively high quantity of times over a relatively short period of time.

As shown by reference number 502, a UE may detect multiple transitions from an LTE frequency to an NR frequency during a period of time. For example, during the period of time (e.g., 120 seconds), the UE may detect that the UE transitioned from a cell global identity (CGI) X1 associated with an LTE frequency to a CGI Y1 associated with an NR frequency at a time T1. Further, the UE may detect a transition from CGI X2 to CGI Y2 at a time T2, as well as a transition from CGI X3 to CGI Y3 at a time T3. In this case, the UE may determine a list that indicates three separate LTE-to-NR reselections over the period of time. The list may indicate a first LTE-to-NR reselection target NR frequency and timestamp pair of (CGI Y1, T1), a second LTE-to-NR reselection target NR frequency and timestamp pair of (CGI Y2, T2), and a third LIE-to-NR reselection target NR frequency and timestamp pair of (CGI Y3, T3). The UE may detect three separate transitions between the LTE network and the NR network over the period of time spanning 120 seconds. The UE may detect the ping-pong behavior based at least in part on a quantity of transitions between the LTE network and the NR network over the period of time satisfying the threshold.

As shown by reference number 504, a UE may detect that the UE has moved from an LTE frequency to an NR frequency, and then back to the LTE frequency within a period of time. For example, the UE may detect that the UE transitioned from CGI X associated with an LTE frequency to a CGI Y associated with an NR frequency. Further, the UE may detect that the UE transitioned from the CGI Y associated with the NR frequency back to the CGI X or to CGI Z associated with the LTE frequency within the period of time (e.g., a same cell or a different cell associated with the LTE frequency). The period of time (e.g., “D”) may be set by a timer. When the UE determines that the UE moved to the LTE frequency and then back to the NR frequency within the period of time (e.g., as set by the timer), the UE may detect the ping-pong behavior.

As indicated above, FIG. 5 is provided as an example. Other examples may differ from what is described with regard to FIG. 5.

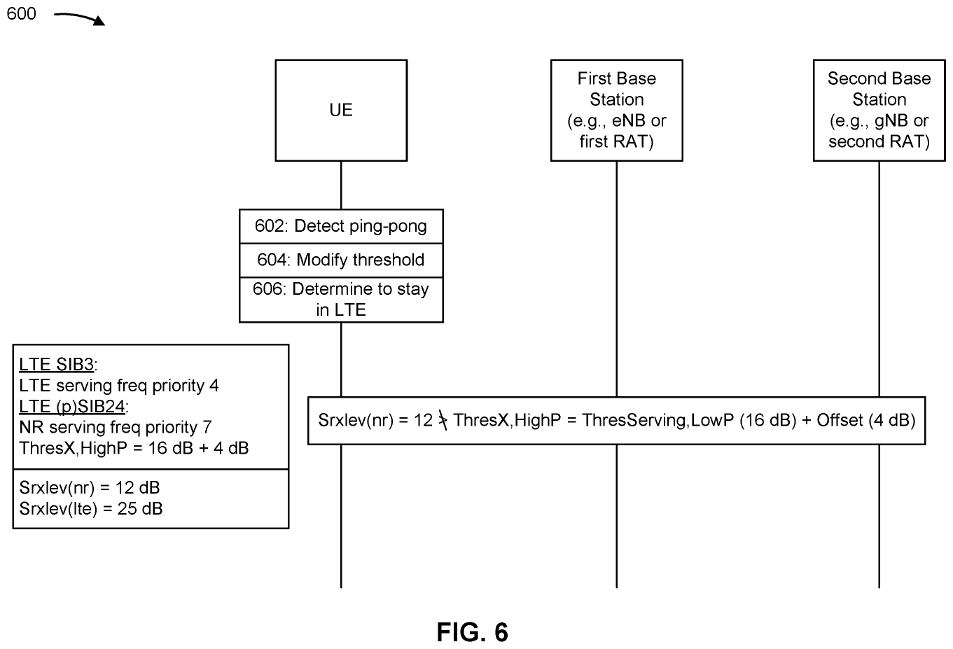

FIG. 6 is a diagram illustrating an example 600 associated with modifying threshold values in a SIB, in accordance with the present disclosure. As shown in FIG. 6, example 600 includes communication between a UE (e.g., UE 120), a first base station (e.g., base station 110a), and a second base station (e.g., base station 110d). In some aspects, the UE, the first base station, and the second base station may be included in a wireless network such as wireless network 100.

In some aspects, the first base station (e.g., an eNB) may be associated with an LTE network, and the second base station (e.g., gNB) may be associated with an NR network. The first base station and the LTE network may be associated with a first RAT and the second base station and the NR network may be associated with a second RAT. In other words, LTE may be associated with the first RAT and NR may be associated with the second RAT.

In some aspects, the UE may receive, from the first base station (e.g., eNB), an LTE SIB3 and an LTE SIB24. The LTE SIB3 and the LTE SIB24 may indicate an LTE serving frequency priority value and an NR neighbor frequency priority value, respectively, that indicate that NR has a higher reselection priority as compared to LTE. In other words, NR may have a higher reselection priority and LTE may have a lower reselection priority. For example, the LTE serving frequency priority value may be 4 and the NR neighbor frequency priority value may be 7, so NR may have a higher reselection priority as compared to LTE.

As shown by reference number 602, the UE may detect a ping-pong behavior at the UE. The UE may detect the ping-pong behavior based at least in part on the UE moving between the LTE network and the NR network a quantity of times over a period of time that satisfies a threshold. Alternatively, or additionally, the UE may detect the ping-pong behavior based at least in part on the UE moving between the LTE network and the NR network within a time period that satisfies a threshold. The UE may detect the ping-pong behavior based at least in part on a list that indicates a plurality of LTE-to-NR reselections, which may indicate LTE-to-NR reselection target NR frequencies and corresponding time stamps.

In some aspects, the UE may detect the ping-pong behavior based at least in part on switching between the LTE network and the NR network based at least in part on a condition. For example, the UE may perform a quantity of switches between the LTE network and the NR network during a time period that satisfies a first threshold. As another example, the UE may switch from the LTE network to the NR network and then back to the LTE network within a time duration that satisfies a second threshold.

As shown by reference number 604, the UE may modify a threshold based at least in part on the ping-pong behavior. More specifically, the UE may modify an NR threshold value (or a second RAT threshold value) in the LTE SIB24 to obtain a modified NR threshold value. The NR threshold value may be ThresX,HighP for an RSRP threshold value and/or ThresX,HighQ for an RSRQ threshold value. The UE may replace the NR threshold value in the LTE SIB24 with an NR threshold value from an NR SIB2 plus an offset, where the NR SIB2 may have been previously received at the UE. The NR threshold value from the NR SIB2 may be ThresServing,LowP for an RSRP threshold value and/or ThresServing,LowQ for an RSRQ threshold value. In other words, the NR threshold value from the NR SIB2 plus the offset may be used to ensure that the NR threshold value of a neighbor NR cell is more than the LTE threshold value of a serving LTE cell.

As an example, the NR threshold value from the NR SIB2 (e.g., ThresServing,LowP and/or ThresServing,LowQ) may be 16 dB and the offset may be 4 dB. Thus, in this example, the NR threshold value in the LTE SIB24 (e.g., ThresX,HighP and/or ThresX,HighQ) may be set to 16 dB plus 4 dB, or 20 dB. The NR SIB2 may have been previously received at the UE when the UE was connected to the second base station in the NR network (e.g., before the ping-pong was detected).

In some aspects, the UE may replace or overwrite the NR threshold value in the LTE SIB24 with the NR threshold value from the NR SIB2 plus the offset, and the overwritten NR threshold value plus offset may be applied in accordance with a timer (e.g., three hours). In other words, the NR threshold value in the LTE SIB24 may be overwritten with the NR threshold value from the NR SIB2 plus the offset for an LTE cell that detects the ping-pong behavior, or alternatively, for a plurality of LTE cells. After the timer expires, the NR threshold value in the LTE SIB24 may be restored, as the NR threshold value from the NR SIB2 plus the offset may expire.

As shown by reference number 606, the UE may determine to stay in the LTE network (e.g., stay connected to the eNB and not connect to the gNB in the NR network) based at least in part on the modified NR threshold value in the LTE SIB24. The UE may determine, based at least in part on a power level of an NR signal, to stay in the LTE network and not connect to the NR network based at least in part on the modified NR threshold value in the LTE SIB24. In other words the modified NR threshold value may be a value that allows the UE to switch from the LTE network to the NR network, but the modified NR threshold value may be higher than the previous NR threshold value in the LTE SIB24. The power level of the NR signal may not satisfy the modified NR threshold value. By determining to stay in the LTE network, the UE may not unnecessarily move to the NR network and then move back to the LTE network within a relatively short period of time, which would increase signaling and power consumption at the UE.

As an example, when the UE is connected to the LTE network, the UE may measure a power level of the NR signal (e.g., Srxlev(nr)) of 12 dB, and the UE may measure a power level of an LTE signal (e.g. Srxlev(lte)) of 25 dB. The power level of the NR signal and the power level of the LTE signal may be based at least in part on RSRP/RSRQ values associated with the NR signal and the LTE signal. The UE may check whether the power level of the NR signal is greater than the modified NR threshold value based at least in part on the NR serving frequency priority value being greater than the LTE serving frequency priority value (e.g., the NR serving frequency priority value of 7 is greater than the LTE serving frequency priority value of 4, so NR has higher priority than LTE). The UE may determine that the power level of the NR signal (e.g., Srxlev(nr)) of 12 dB is not greater than the modified NR threshold value (e.g., 16 dB plus a 4 dB offset, or 20 dB), where the modified NR threshold value is based at least in part on the NR threshold value from the NR SIB2 plus the offset.

In some aspects, the LTE SIB24 may not be broadcast, or a broadcasted LTE SIB24 may not include the NR threshold value. In this case, default NR threshold values may be predefined. For example, a default NR threshold value for RSRP (e.g., ThreshX,HighP) may be 10 dB, and a default NR threshold value for RSRQ (e.g., ThreshX,HighQ) may be 3 dB. Further, the offset may be configured with a default value of 4 dB.

In some aspects, the UE may not receive a broadcast of the LTE SIB24. In this case, the UE may create a local version of an LTE SIB24, which may be referred to as a pseudo SIB24. Irrespective of whether the LTE SIB24 is a broadcasted LTE SIB24 or a locally created pseudo SIB24, the UE may replace or overwrite an NR threshold value with another value plus an offset, depending on a detection of the ping-pong behavior and whether NR has a higher reselection priority than LTE or vice versa.

In some aspects, the UE may generate the pseudo SIB24 based at least in part on NR network information. The NR network information may indicate a public land mobile network (PLMN) identifier, an NR frequency, a subcarrier spacing (SCS) and synchronization signal block (SSB) periodicity, and/or an NR absolute radio-frequency channel number (ARFCN). The NR network information may be stored in a database of the UE. The UE may use the pseudo SIB24 to determine whether to perform a reselection to NR (e.g., migrate from an LTE network to an NR network).

As indicated above, FIG. 6 is provided as an example. Other examples may differ from what is described with regard to FIG. 6.

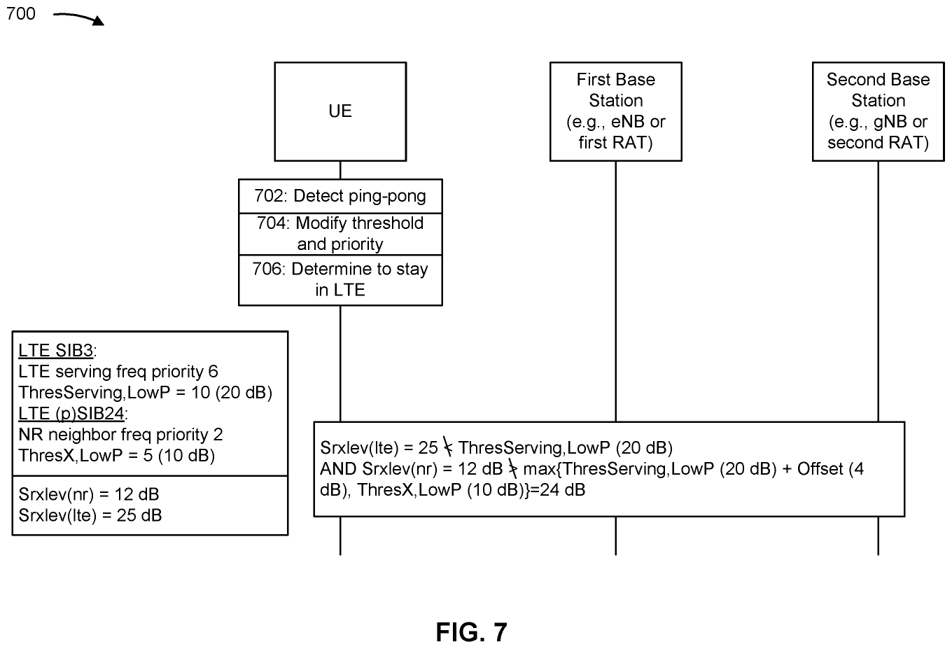

FIG. 7 is a diagram illustrating an example 700 associated with modifying threshold values in a SIB, in accordance with the present disclosure. As shown in FIG. 7, example 700 includes communication between a UE (e.g., UE 120), a first base station (e.g., base station 110a), and a second base station (e.g., base station 110d). In some aspects, the UE, the first base station, and the second base station may be included in a wireless network such as wireless network 100.

In some aspects, the first base station (e.g., an eNB) may be associated with an LTE network, and the second base station (e.g., gNB) may be associated with an NR network. The first base station and the LTE network may be associated with a first RAT and the second base station, and the NR network may be associated with a second RAT. In other words, LTE may be associated with the first RAT and NR may be associated with the second RAT.

In some aspects, the UE may receive, from the first base station (e.g., eNB), an LTE SIB3 and an LTE SIB24. The LTE SIB3 and the LTE SIB24 may indicate an LTE serving frequency priority value and an NR neighbor frequency priority value, respectively, that indicate that LTE has a higher reselection priority as compared to NR. In other words, LTE may have a higher reselection priority and NR may have a lower reselection priority. For example, the LTE serving frequency priority value may be 6 and the NR neighbor frequency priority value may be modified to 2 from 7, so LTE may have a higher reselection priority as compared to NR. Further, the LTE SIB3 may indicate an LTE threshold value (or a first RAT threshold value). The LTE threshold value may be ThresServing,LowP for an RSRP threshold value and/or ThresServing,LowQ for an RSRQ threshold value. The LTE SIB24 may indicate an NR threshold value. The NR threshold value may be ThresX,LowP for an RSRP threshold value and/or ThresX,LowQ for an RSRQ threshold value.

As shown by reference number 702, the UE may detect a ping-pong behavior at the UE. The UE may detect the ping-pong behavior based at least in part on the UE moving between the LTE network and the NR network, over a time period, a quantity of times that satisfies a threshold. Alternatively, or additionally, the UE may detect the ping-pong behavior based at least in part on the UE moving between the LTE network and the NR network within a time period that satisfies a threshold. The UE may detect the ping-pong behavior based at least in part on a list that indicates a plurality of LTE-to-NR reselections, which may indicate LTE-to-NR reselection target NR frequencies and corresponding time stamps.

As shown by reference number 704, the UE may modify a threshold and priority based at least in part on the ping-pong behavior. In the NR network, LTE may have a higher priority than NR. More specifically, the UE may modify the NR threshold value in the LTE SIB24 to obtain a modified NR threshold value. The UE may modify the NR cell reselection priority of the NR frequency with the ping-pong behavior in the LTE SIB24 to obtain a lower NR priority value (e.g., 2), and LTE may have a higher priority than NR in the NR network. In other words, the UE may modify the cell reselection priority of an NR neighbor frequency indicated in the LTE SIB24. The NR neighbor frequency may be associated with the ping-pong behavior. The UE may modify the cell reselection priority of the NR neighbor frequency to be less than LTE. An NR network may configure LTE to have higher priority than NR.

In some aspects, NR may have a lower reselection priority than LTE, and after detecting the ping-pong behavior, the UE may lower a priority of a corresponding NR frequency (e.g., a neighbor NR frequency) to be lower than a priority of an LTE serving frequency.

The NR threshold value may be ThresX,LowP for the RSRP threshold value and/or ThresX,LowQ for the RSRQ threshold value. The UE may replace the NR threshold value in the LTE SIB24 with a maximum value between: the LTE threshold value from the LTE SIB3 plus an offset, and the NR threshold value (e.g., ThresX,LowP and/or ThresX,LowQ). The LTE threshold value from the LTE SIB3 may be ThresServing,LowP for the RSRP threshold value and/or ThresServing,LowQ for the RSRQ threshold value. In other words, the LTE threshold value from the LTE SIB3 plus the offset may be used to ensure that the NR threshold value of a neighbor NR cell is more than the LTE threshold value of a serving LTE cell.

As an example, the LTE threshold value from the LTE SIB3 (e.g., ThresServing,LowP and/or ThresServing,LowQ) may be 20 dB and the offset may be 4 dB. Thus, in this example, the NR threshold value in the LTE SIB24 (e.g., ThresX,LowP and/or ThresX,LowQ) may be set to 20 dB plus 4 dB, or 24 dB.

In some aspects, the UE may replace or overwrite the NR threshold value in the LTE SIB24 with the LTE threshold value from the LTE SIB3 plus the offset, and the overwritten NR threshold value plus offset may be applied in accordance with a timer (e.g., two hours). In other words, the NR threshold value in the LTE SIB24 may be overwritten with the LTE threshold value from the LTE SIB3 plus the offset for an LTE cell that detects the ping-pong behavior, or alternatively, for a plurality of LTE cells. After the timer expires, the NR threshold value in the LTE SIB24 may be restored, as the LTE threshold value from the LTE SIB3 plus the offset may expire.

As shown by reference number 706, the UE may determine to stay in the LTE network (e.g., stay connected to the eNB and not connect to the gNB in the NR network) based at least in part on the modified NR threshold value in the LTE SIB24. The UE may determine, based at least in part on a power level of an NR signal, to stay in the LTE network and not connect to the NR network based at least in part on the modified NR threshold value in the LTE SIB24. By determining to stay in the LTE network, the UE may not unnecessarily move to the NR network and then move back to the LTE network within a relatively short period of time, which would increase signaling and power consumption at the UE.

As an example, when the UE is connected to the LTE network, the UE may measure a power level of the NR signal (e.g., Srxlev(nr)) of 12 dB, and the UE may measure a power level of an LTE signal (e.g. Srxlev(lte)) of 25 dB. The power level of the NR signal and the power level of the LTE signal may be based at least in part on RSRP/RSRQ values associated with the NR signal and the LTE signal. The UE may check whether the power level of the LTE signal is not lower than the LTE threshold value and whether the power level of the NR signal is not greater than the modified NR threshold value based at least in part on the LTE serving frequency priority value being greater than the NR serving frequency priority value (e.g., the LTE serving frequency priority value of 4 is greater than the NR serving frequency priority value of 2, so LTE has higher priority than NR). The UE may determine that the power level of the LTE signal (e.g., Srxlev(lte)) of 25 dB is not less than the LTE threshold value (e.g., ThresServing,LowP and/or ThresServing,LowQ), as indicated in the LTE SIB3. Further, the UE may determine that the power level of the NR signal (e.g., Srxlev(nr)) of 12 dB is not greater than a maximum of: the modified NR threshold value (e.g., 20 dB plus a 4 dB offset, or 24 dB), and the LTE threshold value (e.g., 10 dB), where the modified NR threshold value is based at least in part on the LTE threshold value from the LTE SIB3 plus the offset. As a result, the UE may determine to stay in the LTE network and not connect to the NR network.

In some aspects, the LTE SIB24 may not be broadcast, or a broadcasted LTE SIB24 may not include the NR threshold value. In this case, default NR threshold values may be predefined. For example, default NR threshold values for RSRP (e.g., ThreshX,LowP) may be 10 dB, and default NR threshold values for RSRQ (e.g., ThreshX,LowQ) may be 3 dB. Further, the offset may be configured with a default value of 4 dB.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with techniques for modifying threshold values in a SIB.

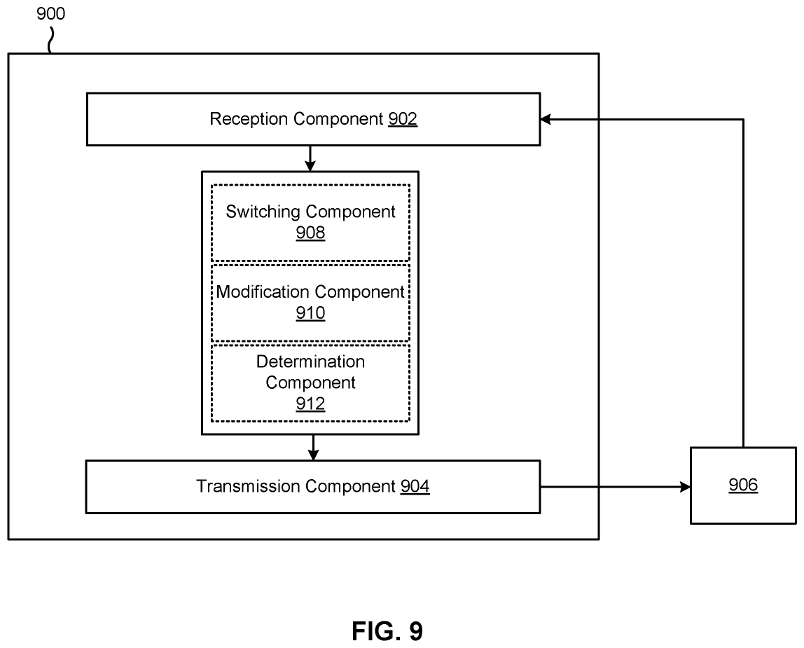

As shown in FIG. 8, in some aspects, process 800 may include switching between a first RAT and a second RAT based at least in part on a condition (block 810). For example, the UE (e.g., using switching component 908, depicted in FIG. 9) may switch between a first RAT and a second RAT based at least in part on a condition, as described above.

As further shown in FIG. 8, in some aspects, process 800 may include modifying, based at least in part on the switching, a second RAT threshold value in a SIB, to obtain a modified second RAT threshold value, wherein the modified second RAT threshold value is a value to switch from the first RAT to the second RAT (block 820). For example, the UE (e.g., using modification component 910, depicted in FIG. 9) may modify, based at least in part on the switching, a second RAT threshold value in a SIB, to obtain a modified second RAT threshold value, wherein the modified second RAT threshold value is a value to switch from the first RAT to the second RAT, as described above.

Process 800 may include additional aspects, such as any single aspect or any combination of aspects described below and/or in connection with one or more other processes described elsewhere herein.

In a first aspect, process 800 includes determining that a signal level associated with the second RAT does not satisfy the modified second RAT threshold value.

In a second aspect, alone or in combination with the first aspect, the first RAT is associated with an LTE network, the second RAT is associated with an NR network, and the modified second RAT threshold value is a modified NR threshold value.

In a third aspect, alone or in combination with one or more of the first and second aspects, switching between the first RAT and the second RAT based at least in part on the condition is based at least in part on a quantity of switches between the first RAT and the second RAT during a time period satisfying a threshold.

In a fourth aspect, alone or in combination with one or more of the first through third aspects, switching between the first RAT and the second RAT based at least in part on the condition is based at least in part on a time duration between the UE switching from the first RAT to the second RAT and switching from the second RAT back to the first RAT satisfying a threshold.

In a fifth aspect, alone or in combination with one or more of the first through fourth aspects, a target cell associated with the second RAT has a higher cell reselection priority than a source cell associated with the first RAT.

In a sixth aspect, alone or in combination with one or more of the first through fifth aspects, a target cell associated with the second RAT has a lower cell reselection priority or an equal cell priority as compared to a source cell associated with the first RAT.

In a seventh aspect, alone or in combination with one or more of the first through sixth aspects, modifying the second RAT threshold value in the SIB, to obtain the modified second RAT threshold value, comprises replacing the second RAT threshold value in a SIB24 with a second RAT threshold value from a previously received second RAT SIB and an offset value.

In an eighth aspect, alone or in combination with one or more of the first through seventh aspects, modifying the second RAT threshold value in the SIB, to obtain the modified second RAT threshold value, comprises replacing the second RAT threshold value in a SIB24 with a first RAT threshold value from a previously received first RAT SIB and an offset value.

In a ninth aspect, alone or in combination with one or more of the first through eighth aspects, the first RAT threshold value is an LTE threshold value and the previously received first RAT SIB is a previously received LTE SIB.

In a tenth aspect, alone or in combination with one or more of the first through ninth aspects, the modified second RAT threshold value is configured to expire based at least in part on an expiry of a timer.

In an eleventh aspect, alone or in combination with one or more of the first through tenth aspects, the modified second RAT threshold value prevents the UE from switching between the first RAT and the second RAT a quantity of times that satisfies a first threshold or within a time duration that satisfies a second threshold.

In a twelfth aspect, alone or in combination with one or more of the first through eleventh aspects, the modified second RAT threshold value is one or more of a second RAT reference signal received power threshold value or a second RAT reference signal received quality power threshold.

In a thirteenth aspect, alone or in combination with one or more of the first through twelfth aspects, modifying the second RAT threshold value in the SIB comprises modifying the second RAT threshold value in a SIB24 locally created at the UE and not broadcasted from a base station associated with the first RAT.

In a fourteenth aspect, alone or in combination with one or more of the first through thirteenth aspects, process 800 includes modifying a cell reselection priority of a second RAT neighbor frequency indicated in the SIB, and the switching is associated with the condition, and the first RAT is associated with a higher cell reselection priority than the second RAT.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of a switching component 908, a modification component 910, or a determination component 912, among other examples.

In some aspects, the apparatus 900 may be configured to perform one or more operations described herein in connection with FIGS. 5-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The switching component 908 may switch between a first RAT and a second RAT based at least in part on a condition. The modification component 910 may modify, based at least in part on the switching, a second RAT threshold value in a SIB, to obtain a modified second RAT threshold value, wherein the modified second RAT threshold value is a value to switch from the first RAT to the second RAT. The determination component 912 may determine that a signal level associated with the second RAT does not satisfy the modified second RAT threshold value.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: switching between a first radio access technology (RAT) and a second RAT based at least in part on a condition; and modifying, based at least in part on the switching, a second RAT threshold value in a system information block (SIB), to obtain a modified second RAT threshold value, wherein the modified second RAT threshold value is a value to switch from the first RAT to the second RAT.

Aspect 2: The method of Aspect 1, further comprising: determining that a signal level associated with the second RAT does not satisfy the modified second RAT threshold value.

Aspect 3: The method of any of Aspects 1 through 2, wherein the first RAT is associated with a Long Term Evolution network, the second RAT is associated with a New Radio (NR) network, and the modified second RAT threshold value is a modified NR threshold value.

Aspect 4: The method of any of Aspects 1 through 3, wherein switching between the first RAT and the second RAT based at least in part on the condition is based at least in part on a quantity of switches between the first RAT and the second RAT during a time period satisfying a threshold.

Aspect 5: The method of any of Aspects 1 through 4, wherein switching between the first RAT and the second RAT based at least in part on the condition is based at least in part on a time duration between the UE switching from the first RAT to the second RAT and switching from the second RAT back to the first RAT satisfying a threshold.

Aspect 6: The method of any of Aspects 1 through 5, wherein a target cell associated with the second RAT has a higher cell reselection priority than a source cell associated with the first RAT.

Aspect 7: The method of any of Aspects 1 through 6, wherein a target cell associated with the second RAT has a lower cell reselection priority or an equal cell priority as compared to a source cell associated with the first RAT.

Aspect 8: The method of any of Aspects 1 through 7, wherein modifying the second RAT threshold value in the SIB, to obtain the modified second RAT threshold value, comprises replacing the second RAT threshold value in a SIB24 with a second RAT threshold value from a previously received second RAT SIB and an offset value.

Aspect 9: The method of any of Aspects 1 through 8, wherein modifying the second RAT threshold value in the SIB, to obtain the modified second RAT threshold value, comprises replacing the second RAT threshold value in a SIB24 with a first RAT threshold value from a previously received first RAT SIB and an offset value.

Aspect 10: The method of Aspect 9, wherein the first RAT threshold value is a Long Term Evolution (LTE) threshold value and the previously received first RAT SIB is a previously received LTE SIB.

Aspect 11: The method of any of Aspects 1 through 10, wherein the modified second RAT threshold value is configured to expire based at least in part on an expiry of a timer.

Aspect 12: The method of any of Aspects 1 through 11, wherein the modified second RAT threshold value prevents the UE from switching between the first RAT and the second RAT a quantity of times that satisfies a first threshold or within a time duration that satisfies a second threshold.

Aspect 13: The method of any of Aspects 1 through 12, wherein the modified second RAT threshold value is one or more of: a second RAT reference signal received power threshold value or a second RAT reference signal received quality power threshold.

Aspect 14: The method of any of Aspects 1 through 13, wherein modifying the second RAT threshold value in the SIB comprises modifying the second RAT threshold value in a SIB24 locally created at the UE and not broadcasted from a base station associated with the first RAT.

Aspect 15: The method of any of Aspects 1 through 14, further comprising: modifying a cell reselection priority of a second RAT neighbor frequency indicated in the SIB, wherein the switching is associated with the condition, and wherein the first RAT is associated with a higher cell reselection priority than the second RAT.

Aspect 16: An apparatus for wireless communication at a device, comprising a processor; memory coupled with the processor; and instructions stored in the memory and executable by the processor to cause the apparatus to perform the method of one or more Aspects of Aspects 1-15.

Aspect 17: A device for wireless communication, comprising a memory and one or more processors coupled to the memory, the memory and the one or more processors configured to perform the method of one or more Aspects of Aspects 1-15.

Aspect 18: An apparatus for wireless communication, comprising at least one means for performing the method of one or more Aspects of Aspects 1-15.

Aspect 19: A non-transitory computer-readable medium storing code for wireless communication, the code comprising instructions executable by a processor to perform the method of one or more Aspects of Aspects 1-15.

Aspect 20: A non-transitory computer-readable medium storing a set of instructions for wireless communication, the set of instructions comprising one or more instructions that, when executed by one or more processors of a device, cause the device to perform the method of one or more Aspects of Aspects 1-15.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
switching between a first radio access technology (RAT) and a second RAT based at least in part on a condition; and
modifying, based at least in part on the switching, a second RAT threshold value in a system information block (SIB), to obtain a modified second RAT threshold value, wherein the modified second RAT threshold value is a value to switch from the first RAT to the second RAT.

2. The method of claim 1, further comprising:
determining that a signal level associated with the second RAT does not satisfy the modified second RAT threshold value.

3. The method of claim 1, wherein the first RAT is associated with a Long Term Evolution network, the second RAT is associated with a New Radio (NR) network, and the modified second RAT threshold value is a modified NR threshold value.

4. The method of claim 1, wherein switching between the first RAT and the second RAT based at least in part on the condition is based at least in part on a quantity of switches between the first RAT and the second RAT during a time period satisfying a threshold.

5. The method of claim 1, wherein switching between the first RAT and the second RAT based at least in part on the condition is based at least in part on a time duration between the UE switching from the first RAT to the second RAT and switching from the second RAT back to the first RAT satisfying a threshold.

6. The method of claim 1, wherein a target cell associated with the second RAT has a higher cell reselection priority than a source cell associated with the first RAT.

7. The method of claim 1, wherein a target cell associated with the second RAT has a lower cell reselection priority or an equal cell priority as compared to a source cell associated with the first RAT.

8. The method of claim 1, wherein modifying the second RAT threshold value in the SIB, to obtain the modified second RAT threshold value, comprises replacing the second RAT threshold value in a SIB24 with a second RAT threshold value from a previously received second RAT SIB and an offset value.

9. The method of claim 1, wherein modifying the second RAT threshold value in the SIB, to obtain the modified second RAT threshold value, comprises replacing the second RAT threshold value in a SIB24 with a first RAT threshold value from a previously received first RAT SIB and an offset value.

10. The method of claim 9, wherein the first RAT threshold value is a Long Term Evolution (LTE) threshold value and the previously received first RAT SIB is a previously received LTE SIB.

11. The method of claim 1, wherein the modified second RAT threshold value is configured to expire based at least in part on an expiry of a timer.

12. The method of claim 1, wherein the modified second RAT threshold value prevents the UE from switching between the first RAT and the second RAT a quantity of times that satisfies a first threshold or within a time duration that satisfies a second threshold.

13. The method of claim 1, wherein the modified second RAT threshold value is one or more of: a second RAT reference signal received power threshold value or a second RAT reference signal received quality power threshold.

14. The method of claim 1, wherein modifying the second RAT threshold value in the SIB comprises modifying the second RAT threshold value in a SIB24 locally created at the UE and not broadcasted from a base station associated with the first RAT.

15. The method of claim 1, further comprising:
modifying a cell reselection priority of a second RAT neighbor frequency indicated in the SIB, wherein the switching is associated with the condition, and wherein the first RAT is associated with a higher cell reselection priority than the second RAT.

16. A user equipment (UE) for wireless communication, comprising:
a memory; and
one or more processors, coupled to the memory, configured to:
switch between a first radio access technology (RAT) and a second RAT based at least in part on a condition;
modify, based at least in part on the switching, a second RAT threshold value in a system information block (SIB), to obtain a modified second RAT threshold value, wherein the modified second RAT threshold value is a value to switch from the first RAT to the second RAT; and
determine that a signal level associated with the second RAT does not satisfy the modified second RAT threshold value.

17. The UE of claim 16, wherein the first RAT is associated with a Long Term Evolution network, the second RAT is associated with a New Radio (NR) network, and the modified second RAT threshold value is a modified NR threshold value.

18. The UE of claim 16, wherein switching between the first RAT and the second RAT based at least in part on the condition is based at least in part on:
a quantity of switches between the first RAT and the second RAT during a time period satisfying a threshold; or
a time duration between the UE switching from the first RAT to the second RAT and switching from the second RAT back to the first RAT satisfying a threshold.

19. The UE of claim 16, wherein:
a target cell associated with the second RAT has a higher cell reselection priority than a source cell associated with the first RAT; or
a target cell associated with the second RAT has a lower cell reselection priority or an equal cell priority as compared to a source cell associated with the first RAT.

20. The UE of claim 16, wherein the one or more processors, to modify the second RAT threshold value in the SIB, to obtain the modified second RAT threshold value, are configured to:
replace the second RAT threshold value in a SIB24 with a second RAT threshold value from a previously received second RAT SIB and an offset value; or
replace the second RAT threshold value in a SIB24 with a first RAT threshold value from a previously received first RAT SIB and an offset value,
wherein the first RAT threshold value is a Long Term Evolution (LTE) threshold value and the previously received first RAT SIB is a previously received LTE SIB.

21. A non-transitory computer-readable medium storing a set of instructions for wireless communication, the set of instructions comprising:
one or more instructions that, when executed by one or more processors of a user equipment (UE), cause the UE to:
switch between a first radio access technology (RAT) and a second RAT based at least in part on a condition; and
modify, based at least in part on the switching, a second RAT threshold value in a system information block (SIB), to obtain a modified second RAT threshold value, wherein the modified second RAT threshold value is a value to switch from the first RAT to the second RAT.

22. The non-transitory computer-readable medium of claim 21, wherein the first RAT is associated with a Long Term Evolution network, the second RAT is associated with a New Radio (NR) network, and the modified second RAT threshold value is a modified NR threshold value.

23. The non-transitory computer-readable medium of claim 21, wherein switching between the first RAT and the second RAT based at least in part on the condition is based at least in part on:
a quantity of switches between the first RAT and the second RAT during a time period satisfying a threshold; or
a time duration between the UE switching from the first RAT to the second RAT and switching from the second RAT back to the first RAT satisfying a threshold.

24. The non-transitory computer-readable medium of claim 21, wherein:
a target cell associated with the second RAT has a higher cell reselection priority than a source cell associated with the first RAT; or
a target cell associated with the second RAT has a lower cell reselection priority or an equal cell priority as compared to a source cell associated with the first RAT.

25. The non-transitory computer-readable medium of claim 21, wherein the one or more instructions further cause the UE to:
replace the second RAT threshold value in a SIB24 with a second RAT threshold value from a previously received second RAT SIB and an offset value; or
replace the second RAT threshold value in a SIB24 with a first RAT threshold value from a previously received first RAT SIB and an offset value,
wherein the first RAT threshold value is a Long Term Evolution (LTE) threshold value and the previously received first RAT SIB is a previously received LTE SIB.

26. An apparatus for wireless communication, comprising:
means for switching between a first radio access technology (RAT) and a second RAT based at least in part on a condition; and
means for modifying, based at least in part on the switching, a second RAT threshold value in a system information block (SIB), to obtain a modified second RAT threshold value, wherein the modified second RAT threshold value is a value to switch from the first RAT to the second RAT.

27. The apparatus of claim 26, wherein the first RAT is associated with a Long Term Evolution network, the second RAT is associated with a New Radio (NR) network, and the modified second RAT threshold value is a modified NR threshold value.

28. The apparatus of claim 26, wherein switching between the first RAT and the second RAT based at least in part on the condition is based at least in part on:
a quantity of switches between the first RAT and the second RAT during a time period satisfying a threshold; or
a time duration between the apparatus switching from the first RAT to the second RAT and switching from the second RAT back to the first RAT satisfying a threshold.

29. The apparatus of claim 26, wherein:
a target cell associated with the second RAT has a higher cell reselection priority than a source cell associated with the first RAT; or
a target cell associated with the second RAT has a lower cell reselection priority or an equal cell priority as compared to a source cell associated with the first RAT.

30. The apparatus of claim 26, further comprising:
means for replacing the second RAT threshold value in a SIB24 with a second RAT threshold value from a previously received second RAT SIB and an offset value; or
means for replacing the second RAT threshold value in a SIB24 with a first RAT threshold value from a previously received first RAT SIB and an offset value,
wherein the first RAT threshold value is a Long Term Evolution (LTE) threshold value and the previously received first RAT SIB is a previously received LTE SIB.
